(19) United States
(12) Patent Application Publication
(10) Pub. No.: US 2012/0280464 A1
(43) Pub. Date: Nov. 8, 2012

(54) ADJUSTABLE LOAD-BEARING WHEELS AND KITS FOR PATIENT LIFTERS

(76) Inventors: Richard L. Nelson, Newburgh, IN (US); Robert M. Levy, Terre Haute, IN (US)

(21) Appl. No.: 13/443,605

(22) Filed: Apr. 10, 2012

Related U.S. Application Data
(63) Continuation-in-part of application No. 12/606,967, filed on Oct. 27, 2009.
(60) Provisional application No. 61/108,694, filed on Oct. 27, 2008.

(51) Int. Cl. B60B 33/04

(52) U.S. Cl. 280/86.75

(57) ABSTRACT

Embodiments of the present disclosure include adjustable wheel assemblies for patient lifts. Actuation of a wheel assembly results in the wheel exerting an increased force on the surface supporting the patient lift, which may decrease the pressure of the remaining patient lift wheels on the support surface. Alternate embodiments include one or more adjustable wheel assemblies in a kit for attachment to a patient lift. A user input component may also be included to provide a single device a user can use to simultaneously actuate the wheel assemblies. Alternate embodiments utilize wedges, hinges, cams, and/or threaded members to increase the force exerted by the wheel on the support surface.

### REFERENCE TO RELATED APPLICATIONS

This application is a continuation-in-part of U.S. patent application Ser. No. 12/606,967, filed Oct. 27, 2009, which claims the benefit of U.S. Provisional Application No. 61/108,694, filed Oct. 27, 2008, the entireties of which are hereby incorporated herein by reference, and this application claims priority to both. Any disclaimer that may have occurred during the prosecution of the above-referenced application(s) is hereby expressly rescinded.

### FIELD

The present invention relates to land vehicles. More particularly, it relates to movable devices with patient transfer features.

### BRIEF DESCRIPTION OF THE DRAWINGS

Some of the figures shown herein may have been created from scaled drawings. However, such relative scaling within a figure is by way of example and is not to be construed as limiting.

FIG. 1 is a perspective view of a patient transfer device according to one embodiment of this disclosure.

FIG. 2 is a perspective view of an indexed linkage means for use in the system of FIG. 1.

FIG. 3 is a perspective view of a stabilization arm connection for use in the system of FIG. 1.

FIG. 4 is a perspective view of a stabilization interface device for use in the system of FIG. 1.

FIG. 5 is a perspective view of a stabilization bracket and interface device for use with the system of FIG. 1.

FIG. 6 is a side view of an alternative stabilization mechanism for use with the system of FIG. 1.

FIG. 7 is a perspective view of another portable patient lifting device according to the present description.

FIG. 8 is a side view of a mobility base with center load-bearing wheels in another embodiment according to the present description.

FIG. 9 is a side view of the embodiment of FIG. 8 with its center wheels raised.

FIG. 10 is a side view of the embodiment of FIG. 8 with its center wheels lowered.

FIG. 11 is a perspective view of a wheel assembly and actuation assembly according to one embodiment of the present disclosure.

FIG. 12 is a partial perspective view of the wheel assembly and actuation assembly depicted in FIG. 11 with the wheels in a weight-bearing orientation.

FIG. 13 is a partial perspective view of the wheel assembly and actuation assembly depicted in FIG. 11 with the wheels in a non-weight-bearing orientation.

FIG. 14 is a side elevational view of a wheel assembly in a non-weight-bearing orientation according to another embodiment of the present disclosure.

FIG. 15 is a side elevational view of the wheel assembly depicted in FIG. 14 in a weight-bearing orientation.

FIG. 16 is a side elevational view of a wheel assembly in a non-weight-bearing orientation according to yet another embodiment of the present disclosure.

FIG. 17 is a perspective view of the wheel assembly depicted in FIG. 16 with at least one component not depicted for clarity.

FIG. 18 is a side elevational view of the wheel assembly depicted in FIG. 16 in a weight-bearing orientation.

FIG. 19 is a side elevational view of a wheel assembly in a non-weight-bearing orientation according to still a further embodiment of the present disclosure.

FIG. 20 is a side elevational view of the wheel assembly depicted in FIG. 19 in a weight-bearing orientation.

FIG. 21 is a side elevational view of a wheel assembly in a non-weight-bearing orientation according to still another embodiment of the present disclosure.

FIG. 22 is a side elevational view of the wheel assembly depicted in FIG. 21 in a weight-bearing orientation.

FIG. 23 is a perspective view of a wheel assembly in a non-weight-bearing orientation according to an additional embodiment of the present disclosure.

FIG. 24 is a perspective view of the wheel assembly depicted in FIG. 23 in a weight-bearing orientation.

FIG. 25 is a perspective view of a load-bearing wheel assembly and actuation assembly with the wheels in a non-load-bearing orientation (and at least one component of a wheel assembly not depicted for clarity) according to one embodiment of the present disclosure.

FIG. 26 is a perspective view of the wheel assembly and actuation assembly depicted in FIG. 25 with the wheel assembly in a load-bearing orientation.

FIG. 27 is a partial perspective view of the wheel assembly and actuation assembly depicted in FIG. 25 with the wheel assembly in a non-load-bearing orientation.

FIG. 28 is a partial perspective view of the wheel assembly and actuation assembly depicted in FIG. 25 with the wheel assembly in a load-bearing orientation.

FIG. 29 is a perspective view of a wheel assembly and actuation assembly according to still another embodiment of the present disclosure.

FIG. 30 is a perspective view of the wheel assembly and actuation assembly depicted in FIG. 29 attached to a patient lift.

FIG. 31 is a bracket for attaching portions of a wheel assembly and/or actuation assembly to a patient lift according to a further embodiment of the present disclosure.

FIG. 32 is a side elevational view of the bracket depicted in FIG. 31.

FIG. 33 is a perspective view of the bracket depicted in FIG. 31 attached to a wheel assembly according to one embodiment of the present disclosure.

FIG. 34 is a perspective view of the bracket depicted in FIG. 31 with one or more optional adapters according to one embodiment of the present disclosure.

### DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to “advantages” provided by some embodiments of the present invention, other embodiments may not include those same advantages, or may include different advantages. Any advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

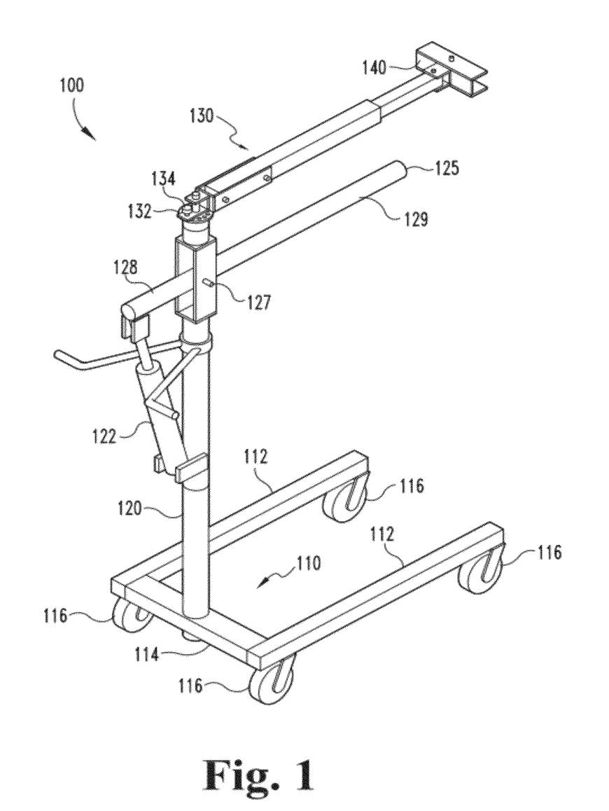

Generally, this disclosure relates to a device and an associated method for transferring a person having a mobility impairment from one location to another, such as transferring between a wheelchair and a bathtub, or between a wheelchair and a bed. One embodiment described herein includes five major components: a mobility base, a post and lifter arm, a stabilization arm, a stabilization interface, and a stabilization bracket. A perspective view of this embodiment is shown in FIG. 1.

Mobility base 110 comprises a tubular frame with side members 112 and cross member 114, with casters 116 attached to effect mobility of the lifter 100. The casters 116 can all be locked, when required, for positional stability of the lifter 100. Each caster 116 swivels when unlocked. The casters 116 lock and unlock simultaneously upon activation of a single lever, footpad, or other control mechanism (not shown). When casters 116 are locked, they can neither swivel about the caster stem bearings, nor roll about the caster axles. The base side pieces 112 and 114 can be moved so as to increase the width of the base to optimize lifter stability when desired, or to effect transfers from wider wheelchairs, lift chairs, or the like.

Lifter post 120 is attached to a cross member 114 of the mobility base frame 110. The lifter post 120 in this embodiment is removable from the base to allow for shipping, transporting in a vehicle, storage, and the like. The post can be attached at multiple locations along the cross member 114 of the base frame 110 in order to reduce the required length of the lifter arm 125 and stabilization arm 130. Attached to the lifter post 120 is a lifter arm 125. The lifter arm 125 is attached to the post 120 with an offset pivot point 127 (so it has a short end 128 and a long end 129) so it pivots up and down to allow a client to be lifted over the wall of a bathtub, off of a bed, etc. while hanging from the long end 129 of the lifter arm 125 in a sling (not shown). An actuator device 122 is attached to the short end 128 of the lifter arm 125 and to a position on lifter post 120 below pivot point 127, to provide the mechanical push and pull required to pivot (raise or lower) the lifter arm 125 as required during use. The actuator device 122 and lifter arm 125 are attached to the post in such a way that they can pivot 360 degrees about the post 120 to perform side and rear transfers as required. Push handles 124 for maneuvering the lifter are also attached to the lifter post 120.

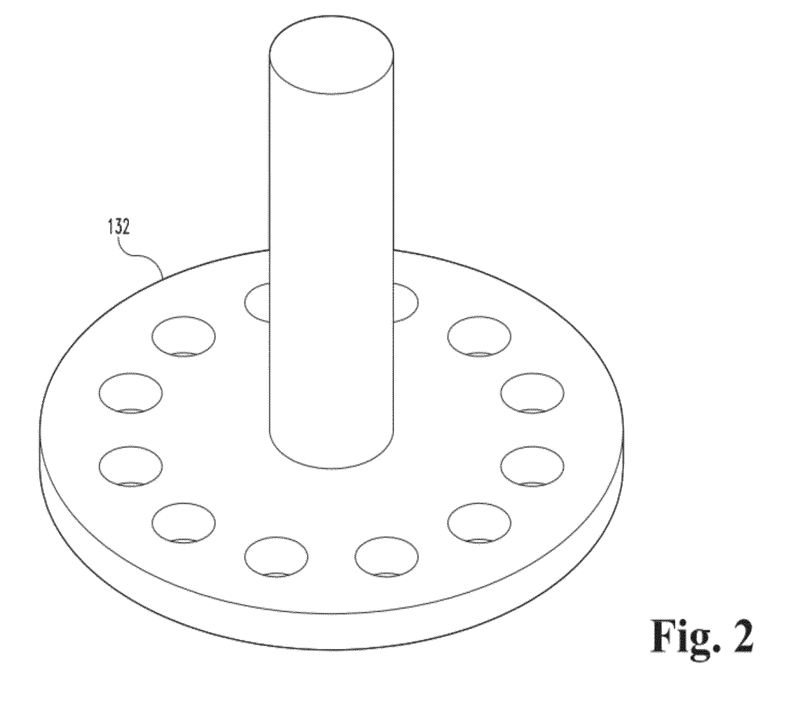

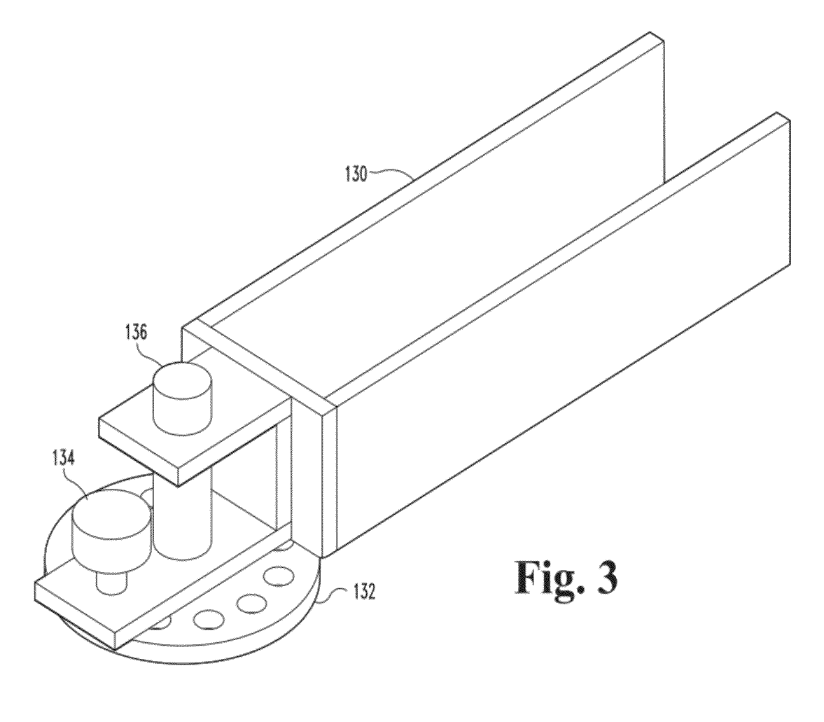

A stabilization arm 130 is attached to the lifter post 120 in a way that allows it to be rotated 360 degrees about indexed linkage means 132 at the top of the lifter post 120, and is securely indexed at multiple angles to the post to effect transfers in multiple relative angular configurations. (See also FIGS. 2-3.) The stabilization arm 130 is designed to fold out of the way when not in use, or to be detached if the device is being used only as a traditional lifter. The stabilization arm is adjustable in length to effect transfers in multiple configurations and situations. The attachment point of stabilization arm 130 to the lifter post 120 can be varied in height to effect transfers in multiple configurations.

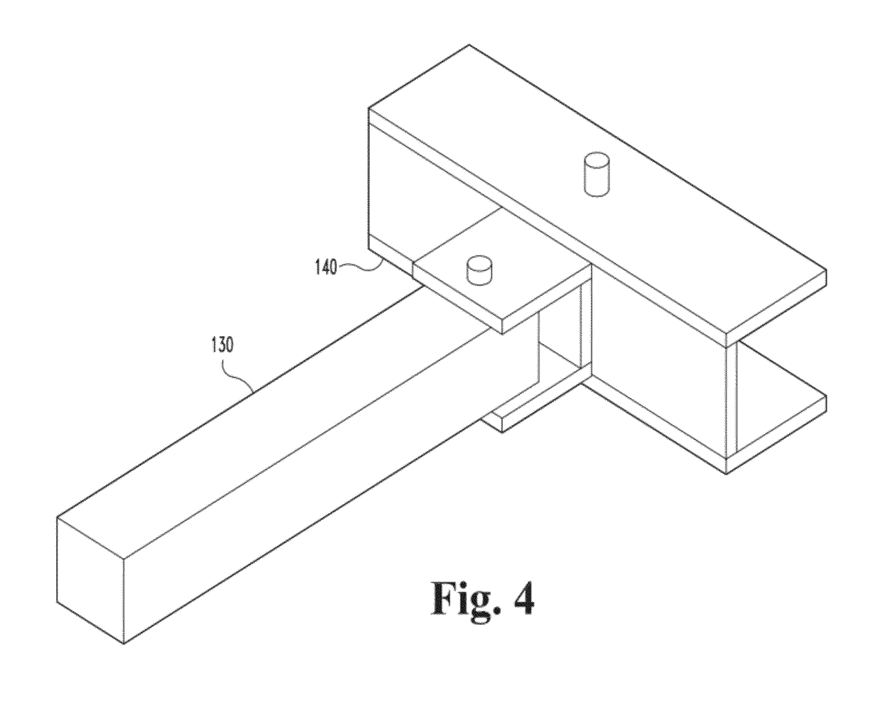

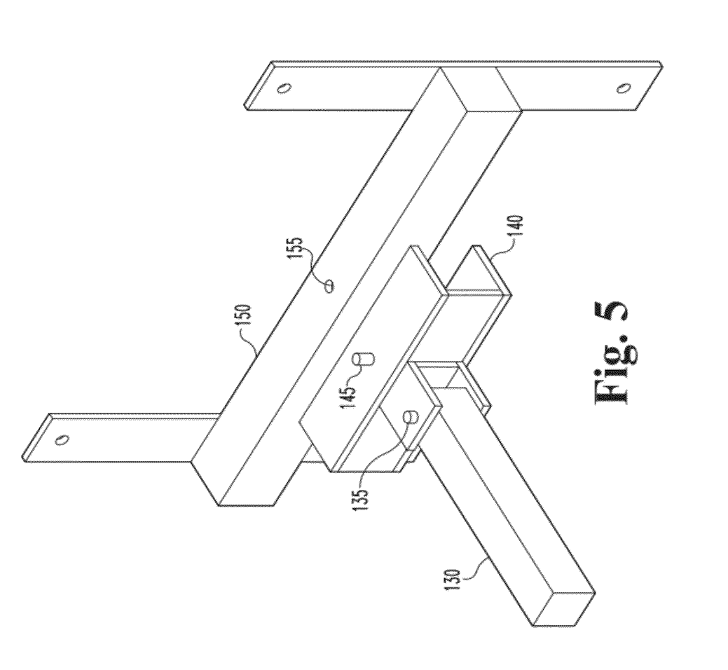

A stabilization interface device 140 is attached to the end of the stabilization arm 130 opposite to the post attachment point. As illustrated in FIG. 4, the stabilization interface device 140 is attached pivotally to the stabilization arm 130 to allow stabilization of the lifter in multiple configurations. It contains a mechanism that assures a rigid, safe connection with the stabilization bracket 150 (see FIG. 5). This attachment is robust, but is easily engaged and disengaged. In some embodiments, once the transfer is complete, the stabilization interface device 140 can be remotely detached from the stabilization bracket 150 so the lifter can be moved. This remote detachment is enabled in various embodiments by cables, pulleys, levers, motors, servos, and other mechanisms and techniques as will occur to those skilled in the relevant areas of technology in light of this disclosure.

As shown in FIG. 5, a stabilization bracket 150 is securely attached to a wall in the vicinity of the transfer site. The stabilization interface device 140 on the end of the stabilization arm 130 securely latches to the wall-mounted stabilization bracket 150 to stabilize the lifter relative to the wall during transfers. In particular, spring-loaded pin 145 is urged into hole 155 when the three plates of stabilization interface device 140 are properly positioned around the three exposed sides of stabilization bracket 150. This arrangement substantially prevents vertical movement of stabilization arm 130 when the mechanism is attached, but allows rotational movement about pin 135, which permits placement in a variety of positions even where only a single stabilization bracket 150 is available. Multiple stabilization brackets 150 can be placed in different locations to enable stabilized transfers at each one, and several additional variations in configuration will be understood by those skilled in the relevant technology in view of this disclosure.

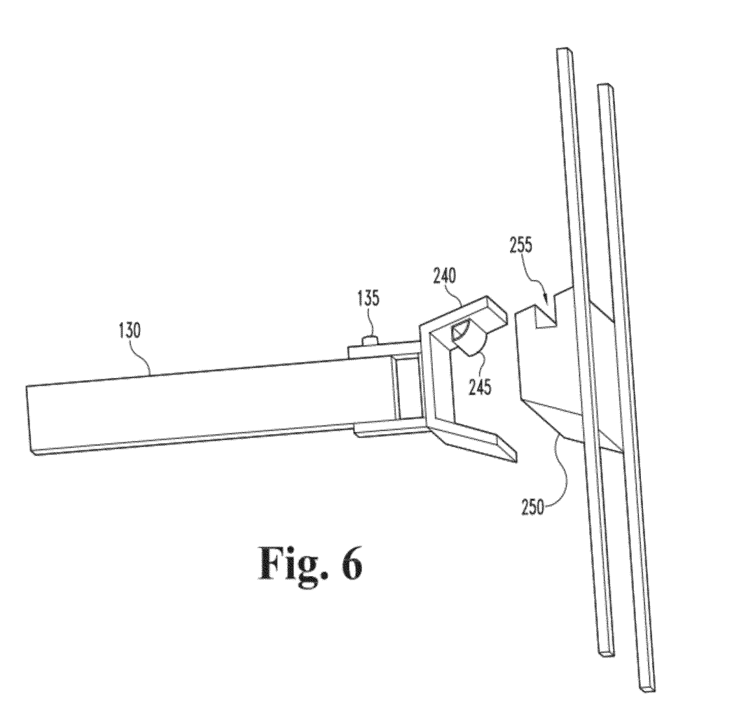

FIG. 6 illustrates an alternative stabilization mechanism for use with the disclosed system. In this embodiment, stabilization arm 130 again rotates about pivot pin 135 to enable placement of post 120 in a variety of relative positions. In this attachment mechanism, however, stabilization interface device 240 has a wider opening than that of stabilization interface device 140, and bracket 250 has matching angles between its outer faces. Further, stabilization interface device 240 has stabilization retainer 245, which rests in slot 255 of stabilization bracket 250 when the device is securely in place. Stabilization retainer 245 in some embodiments is fixedly attached to the underside of the top panel of stabilization interface device 240, while in others it is only temporarily secured in position but can rotate up and out of the way as the components are joined, or can be slid into channel 255 from the end of the channel. Alternative placements, forms, arrangements, and even attachment techniques will occur to those skilled in the art based on this disclosure.

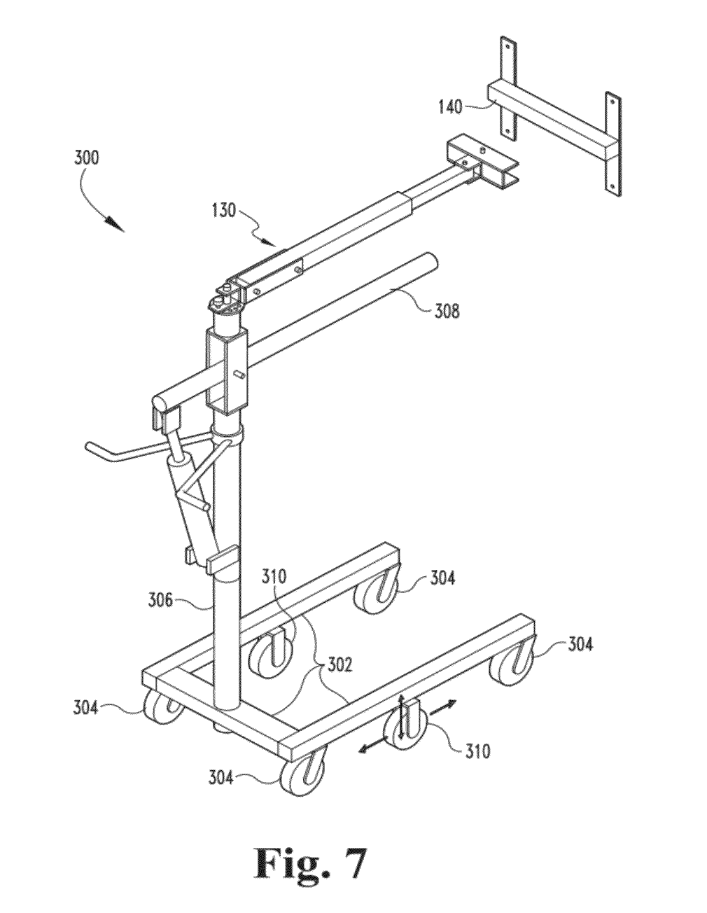

Another embodiment, illustrated in FIG. 7, is a portable patient lifting device 300 normally comprising a base 302 with two front and two rear swiveling casters 304 that provide mobility for the unit, a post 306 vertically attached to the base 302, and a lifter arm 308 rotationally attached to the top of the post 306. The device 300 also has attached to the base 302, between the front and rear casters 304, at least two, but possibly more, adjustable load-bearing drive wheels 310 that do not swivel as casters do. These “load-bearing wheels” 310 are adjustable in height in relation to the bottom of the lifter base 302 and the four casters 304, so the load-bearing wheels 310 can, when desired, be adjusted to be lower in height than the base 302 and casters 304, essentially allowing them to bear more of the load of the lifter system 300 than the four swiveling casters 304 do. When the load-bearing wheels 310 are in this position, this adjustment essentially decreases the load on the axles and swivel bearings of the four casters 304, thereby decreasing the effort required for a person to push or pull the lifter system 300.

An added benefit of the lowered position of the load-bearing wheels 310 is that the lifter 300 is easier for a caregiver to maneuver because it tracks in a more straight line over distances, and turns more easily in confined spaces, such as in situations where a sharp 90-degree turn maneuver is required to go from a hallway through a door, etc. The load-bearing wheels 310 can be raised to allow the lifter 300 to be maneuvered freely in all directions, unlimited by the friction of the load-bearing wheels 310 against the surface, and to allow the four casters 302 to provide maximum stability during transfer of a patient.

The adjustment in height of the load-bearing wheels 310 can be accomplished in many ways. In one example, the adjustment is accomplished by a rotating cam attached to a lever or some other mechanical device that reliably and easily accomplishes the vertical adjustment of the load-bearing wheels. In other examples, the adjustment is achieved by powered and/or hydraulic-assisted mechanisms, which include servo and piezoelectric actuators. These mechanisms may be controlled remotely, such as by a wired or wireless controller that can be attached to (optionally removably attached to) the patient lift. Further example embodiments include the wheel assemblies depicted in the remaining figures of this disclosure.

In some variations of this embodiment, the horizontal position of the load-bearing wheels 310 along the frame of the base 302 can also be adjusted, as illustrated by the non-vertical arrows near wheels 310 in FIG. 7. The adjustment is normally from front-to-back between the four casters 302, allowing the load-bearing wheels 310 to be placed, as necessary or preferred, directly below the center of mass of the lifter. This adjustability allows users to optimize the stability, maneuverability, and versatility of the lifter 300.

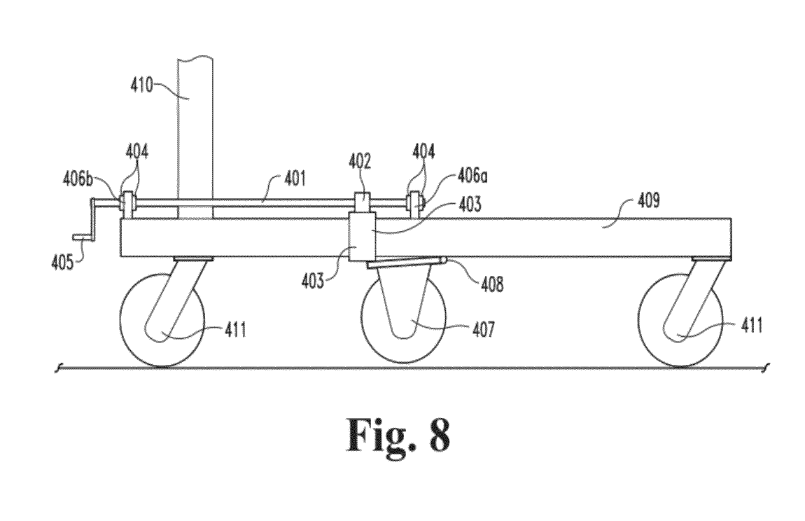

One variation of the placement, operation, and movement of load-bearing wheels 310 is shown in FIGS. 8-10. The front and rear ACME screw posts 406a and 406b are rigidly connected to the top surface of the lifter base. The ACME screw 401 is held in vertical and horizontal alignment by the front and rear ACME screw posts 406a and 406b, and the four shaft collars 404. The ACME screw 401 is allowed to rotate freely through holes drilled in the front and rear screw posts 406a and 406b. The shaft collars 404 prevent the ACME screw from moving horizontally in relation to the ACME screw posts 406a and 406b. As the ACME screw 401 is rotated with the ACME screw crank handle 405, the ACME screw nut 402 and the wedge 403, which are rigidly connected to each other, move back and forth along the lifter base 409. The center load-bearing wheel assembly 407 is attached to the underside of the lifter base 409 by a pivot point 408.

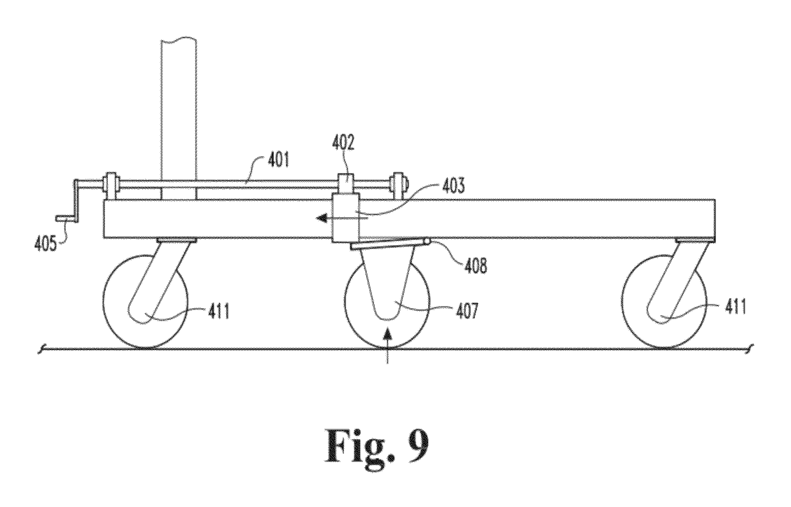

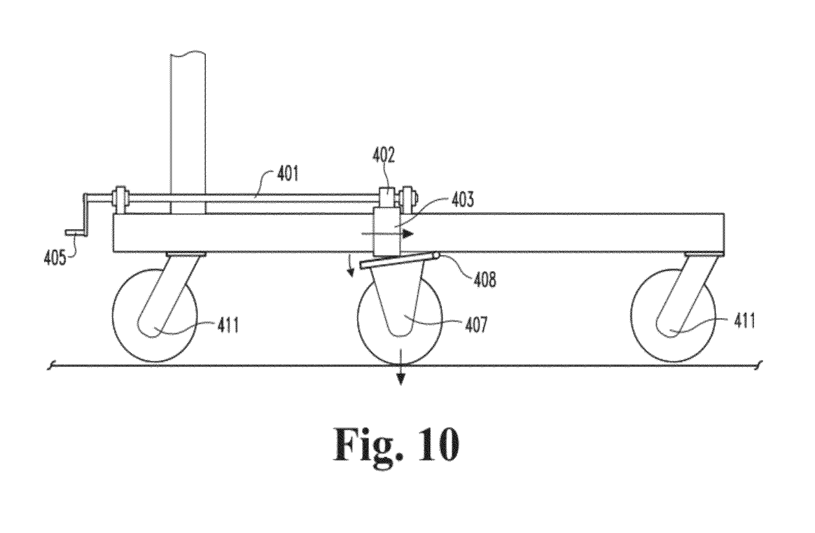

The ACME screw nut 402 and wedge 403 are positioned in relation to the load-bearing wheel pivot point 408 so that, as the ACME screw nut 402 and wedge 403 are moved back and forth by rotation of the ACME screw 401, the center load-bearing wheel assembly 407 moves up (see FIG. 9) and down (see FIG. 10) in relation to the front and rear casters 411. This wedging action effectively offloads the front and rear casters 411, allowing the lifter to be pushed, pulled, and maneuvered much more easily.

In other variations (e.g., other variations of the lifter depicted in FIG. 1), only two of the wheels are castors, while two others (such as the “rear” wheels on the corners nearest the post) are wheels that are held in fixed orientation relative to the lifter base. This configuration can provide somewhat better straight-line tracking than the four-castor version.

Still further embodiments of the present disclosure include wheel assemblies and/or actuation assemblies, which may be used in kits for installing load-bearing wheel assemblies on patient lifts. The wheel assemblies and/or actuation assemblies may be used as the original set of wheels on a patient lift, or to retrofit existing patient lifts, especially when included as a kit. When used to retrofit an existing patient lift, a kit enables use of the load-bearing wheels with a variety of commercially available portable patient lifters to increase the safety and maneuverability of these preexisting lifters.

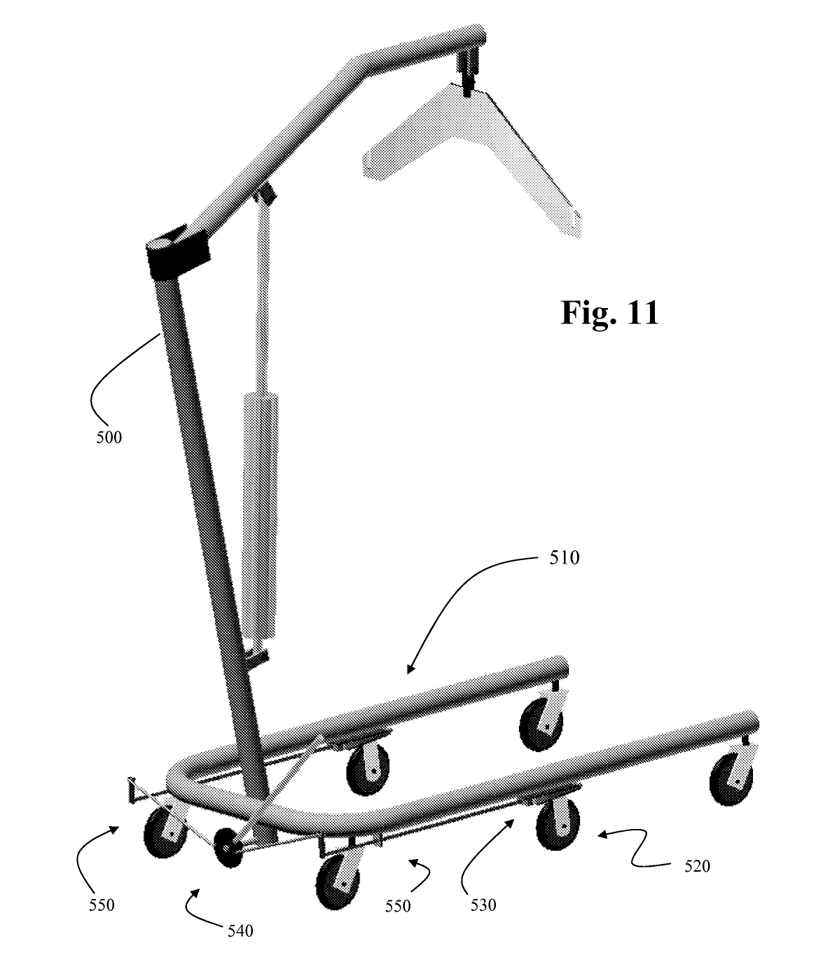

One example wheel assembly and actuation assembly, shown as kit 510, is depicted in FIGS. 11-13 as installed on a patient lift 500. Kit 510 includes at least one wheel assembly 520, a user input assembly 540, and linkages 550 connecting user input assembly 540 to the one or more wheel assemblies 520.

Each wheel assembly 520 includes at least one wheel 521, a wheel mount 523 connected to the wheel, and a wheel pressure actuator 530 for adjusting the force of wheel 521 on the surface supporting patient lift 500. The wheel pressure actuator 530 in FIGS. 11-13 includes a separation member (e.g., wedge 525), which can apply or remove a force on wheel mount 523 and frame member 527 directed to separate at least portions of wheel mount 523 and frame member 527. Wheel mount 523 and frame member 527 are connected by a member that allows application of pressure between wheel mount 523 and frame member 527. In the illustrated embodiment, wheel mount 523 and frame member 527 are connected at one end by a hinge 529.

Movement of wedge 525 toward hinge 529 increases the force directed to separate frame member 527 and wheel mount 523, which tends to actuate hinge 529 in the opening direction. The increased separation force between wheel mount 523 and frame member 527 will increase the load carried by the wheel assembly 520. If wheel 521 is not in contact with the support surface (e.g., floor) or if the upward force of the support surface on wheel 521 is sufficiently small, wheel 521 will move downward. If wheel 521 is already in contact with the support surface, wheel 521 may not move downward as the separation force between wheel mount 523 and frame member 527 increases, increasing the load carried by wheel assembly 520.

Movement of wedge 525 away from hinge 529 results in decreasing the force directed to separate frame member 527 and wheel mount 523, which tends to actuate hinge 529 in the closing direction. In some embodiments, movement of wedge 525 away from hinge 529 can result in frame member 527 and wheel 521 moving upward off of the support surface.

Wedge 525 includes a threaded receptacle into which a threaded portion of a torsion rod 557 is received. Two torsion rods 557a and 557b are depicted in the illustrated embodiment, one for each wheel assembly 520. The axis of rotation of each torsion rod 557 is generally parallel to the support surface (e.g., floor). Depending on the direction of rotation of torsion rod 557, wedge 525 moves either toward hinge 529 or away from hinge 529.

Mounts 555 and 558 are optionally included and restrict the motion of torsion rod 557 in directions perpendicular to the direction of rotation.

Each torsion rod 557 is connected to a crank 553, which is in turn connected to a push/pull rod 551. Each push/pull rod 551 is connected to a central crank 543, which is connected to a handle 541.

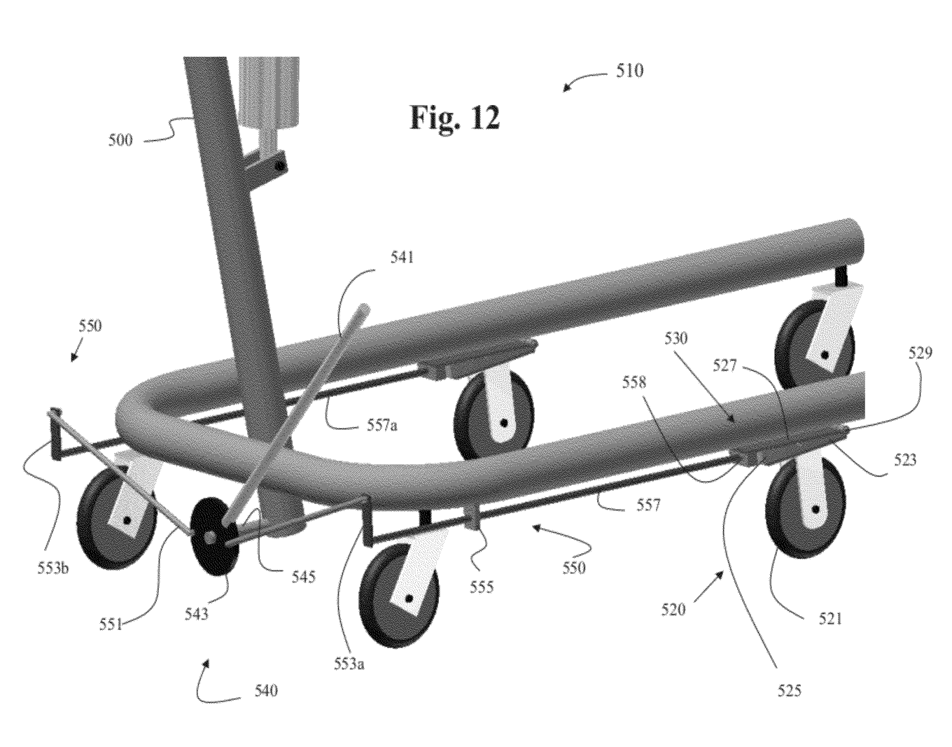

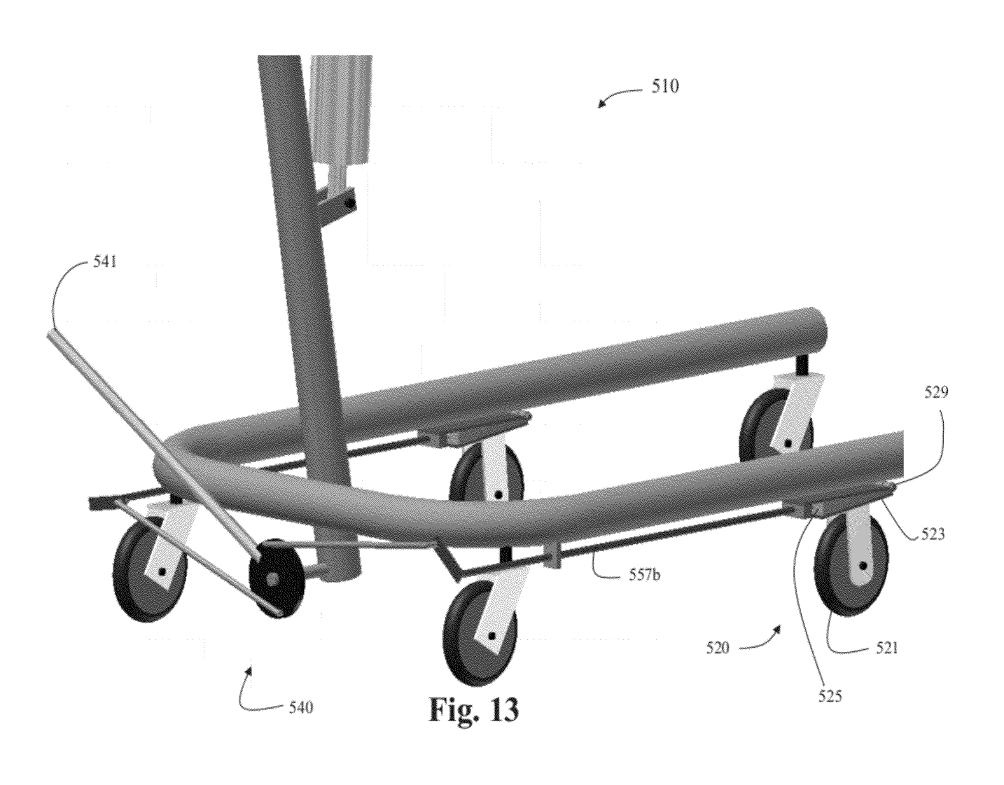

In use, a user grasps and moves handle 541, which in turn rotates crank 543. Referring to FIGS. 12 and 13, a counterclockwise rotation of handle 541 results in a counterclockwise rotation of crank 543, which results in push/pull rods 551 rotating crank 553a counterclockwise and crank 553b clockwise. These rotations of cranks 553a and 553b result in corresponding rotations of their respective torsion rods 557, and the threaded ends of torsion rods 557 that are received within wedges 525 result in the movement of wedges 525 either toward or away from hinges 529. It should be appreciated that, in the illustrated embodiment, the threading of torsion rod 557a is in the opposite direction of the threading of torsion rod 557b and wedges 525 move in the same direction either toward or away from the respective hinge of each wedge 525 as handle 541 is rotated.

FIG. 13 depicts kit 510 with handle 541 rotated to extend wedges 525 toward their respective hinges, thereby increasing the downward pressure of wheels 521 of the support surface. Rotation of handle 541 from the position depicted in FIG. 13 to the position depicted in FIG. 12 moves wedges 525 away from their respective hinges 529, thereby decreasing the pressure of wheels 521 against the support surface. In situations where wheel 521 moves, the movement of wheel 521 may be imperceptible, the total travel in some embodiments being approximately ⅜ of one inch.

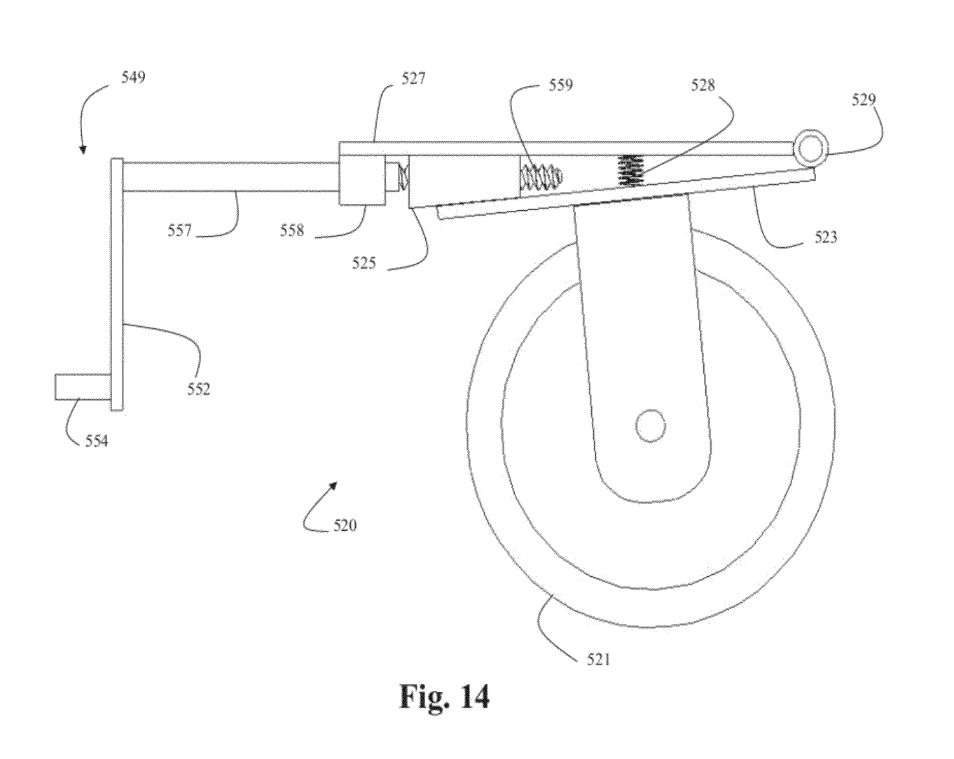

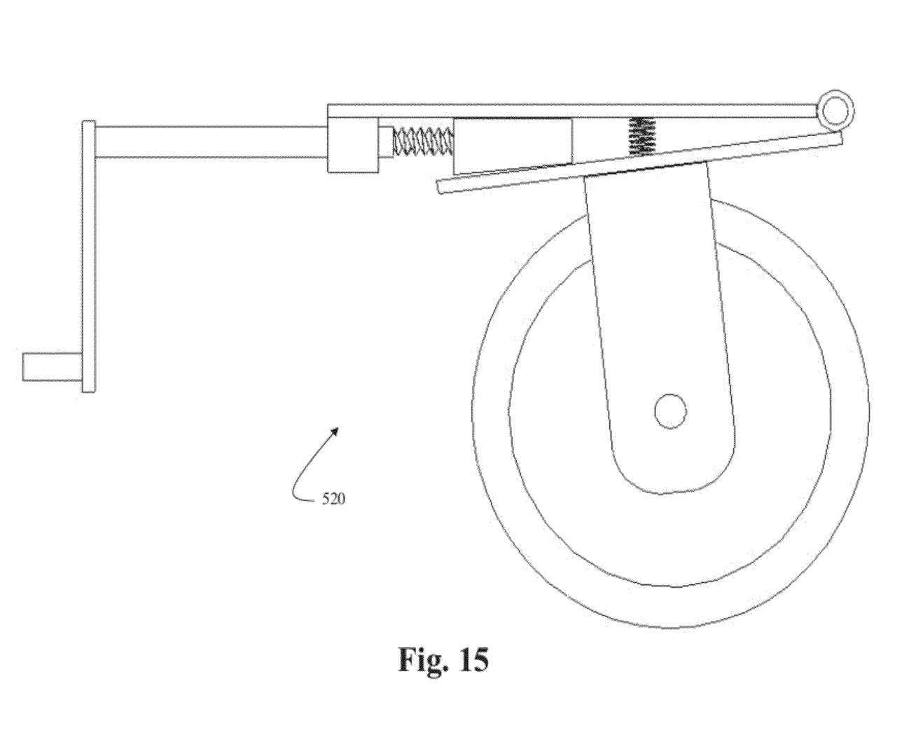

When wheel assemblies 520 are actuated to decrease the downward pressure of wheels 521 on the support surface (e.g., ground), the weight of patient lift 500 can force wheels 521 upward until the weight of patient lift 500 (and any additional weight, such as the weight of a patient, being held by patient lift 500) is distributed on the remaining wheels. To continue the upward motion of wheels 521 and raise wheels 521 off of the support surface, an optional lift member may be included. In one form, the lift member may include a slotted tongue-in-groove connection between wedge 525 and wheel mount 523. In other embodiments, a spring (see FIGS. 14 and 15) is used to raise wheel 521 off of the support surface.

Installation of kit 510 on a patient lift, such as patient lift 500, includes connecting user input assembly 540, linkages 550, and wheel assembly 520 to the frame of patient lift 500. For example, attachment members 545, 555 and 558 (and optionally, frame member 527 when included) may be initially connected to the frame of patient lift 500. The remaining portions of kit 510 (e.g., wheel assembly 520, user input assembly 540, and linkages 550) may then be connected to patient lift 500 using one or more attachment members, which may take the form of brackets, threaded members, rivets, clamps, bonding agents (which can include adhesives and molten metal, e.g., welding), or the like.

Depicted in FIGS. 14 and 15 is an expanded view of wheel assembly 520 and an alternate user input assembly according to another embodiment of the present disclosure. This embodiment includes a separate user input assembly 549 with a crank 552 and handle 554 for separately adjusting each wheel assembly 520. Rotation of handle 554 causes a rotation of torsion rod 557 about a horizontal axis. The threaded end 559 of torsion rod 557 moves wedge 525 either toward or away from hinge 529, depending on the direction of rotation of handle 554 and the direction of the threads in threaded end 559. When handle 554 is rotated sufficiently to move wedge 525 away from hinge 529 to a point where wheel 521 no longer carries weight from patient lift 500, the wheel lift member (for example spring 528) can, in some embodiments, lift wheel 521 off of the support surface.

FIG. 15 depicts the wheel assembly 520 with wheel 521 extended downward to a lower position than that depicted in FIG. 14.

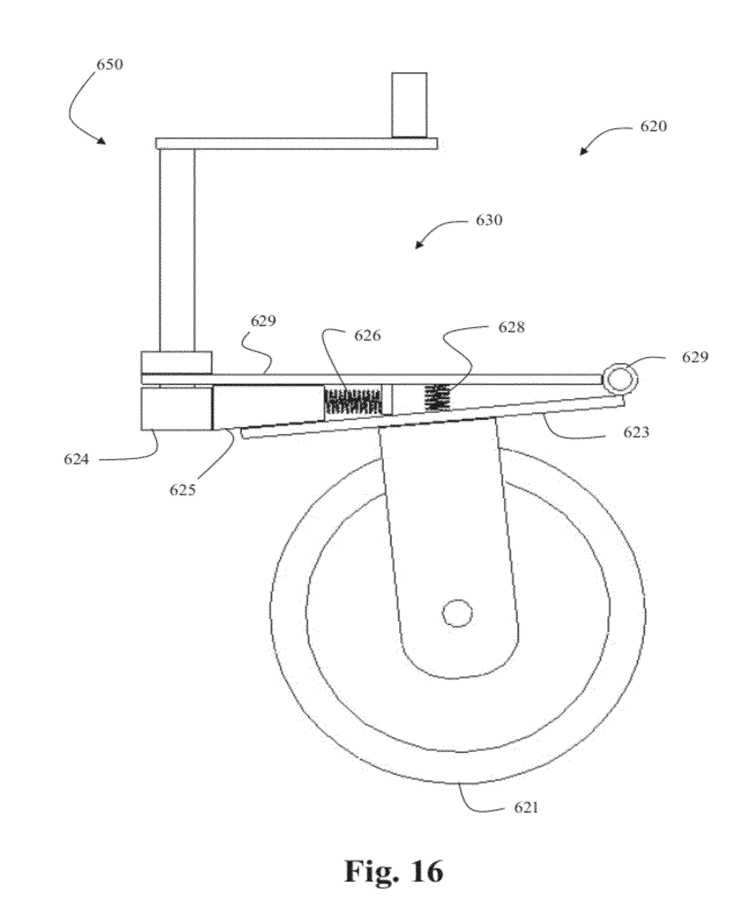

Depicted in FIGS. 16-18 is a wheel assembly 620 according to another embodiment of the present disclosure. Wheel assembly 620 includes at least one wheel 621 connected to a wheel mount 623, which is connected to a frame member 627, which optionally may be a portion of a patient lift. A wheel pressure actuator 630 is included for adjusting the force of wheel 621 on the support surface. A separation member, for example wedge 625, can apply or remove a force between wheel mount 623 and frame member 627 directed to increase or decrease, respectively, the downward force of wheel 621 on the support surface. Depending on the amount of weight carried by wheel 621, the movement of wedge 625 to and from hinge 629 will separate (or decrease the distance between), at least portions of, wheel mount 623 and frame member 627.

Handle 650 rotates a cam 624 about a vertically oriented axis to apply (or remove) a force to wedge 625 and move wedge 625 toward hinge 629. An optional return spring 626 applies a force to wedge 625 directed away from hinge 629, and can be used to move wedge 625 away from hinge 629 when cam 624 is rotated to allow movement of wedge 625 away from hinge 629. An optional coupling between cam 624 and wedge 625 or the forces produced by the angled orientation of the frame member 629 and wheel mount 623 may also be used, either individually or in various combinations including spring 628, to move wedge 625 away from hinge 629.

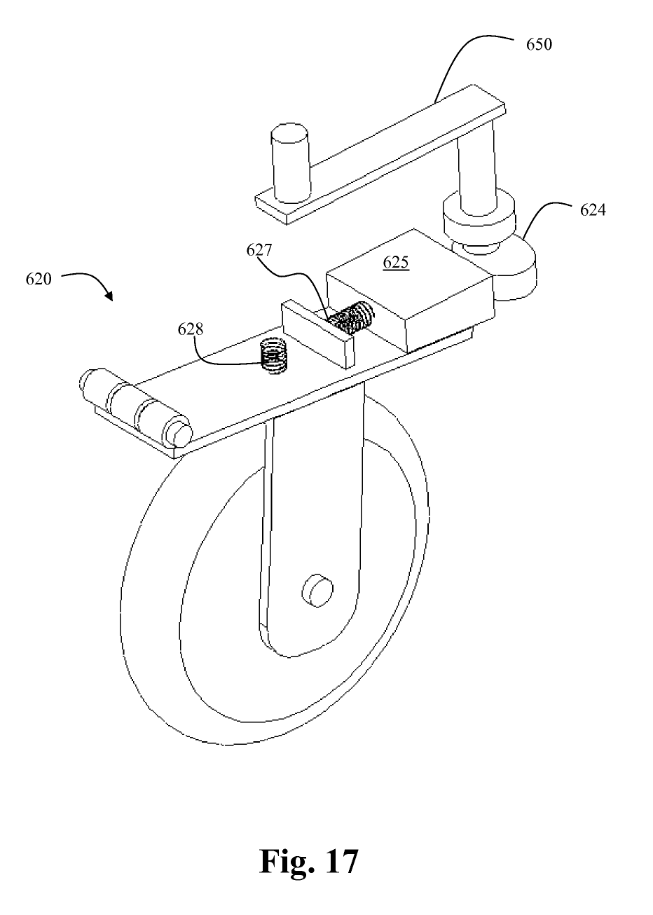

FIGS. 16 and 17 depict wedge 625 in a retracted orientation, allowing wheel 621 to be in a low applied force orientation, or even a raised orientation. A wheel lift member (for example spring 628) can be used to continue the upward movement of wheel 621 once wheel 621 is no longer in contact with the support surface.

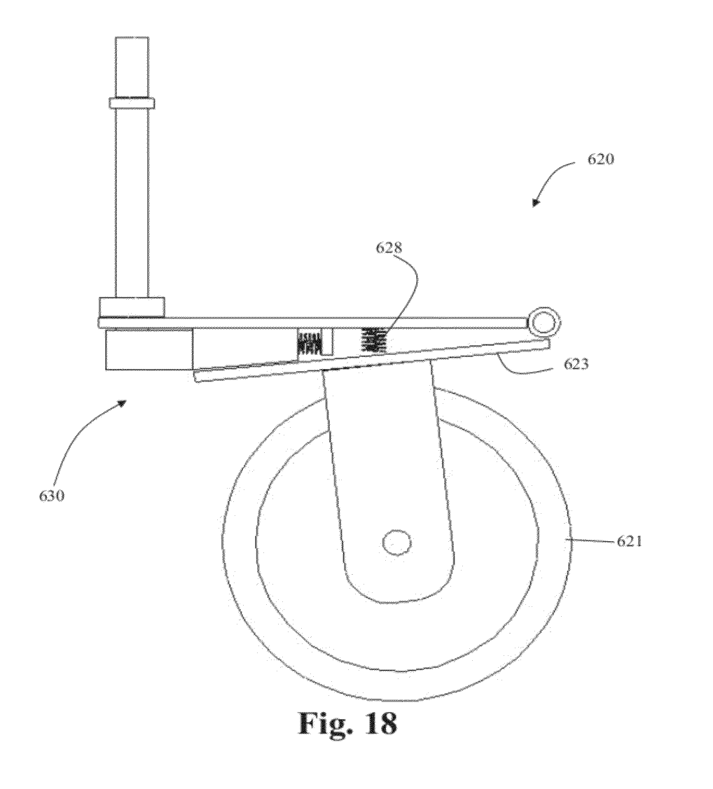

FIG. 18 depicts cam 624 rotated to orient wedge 625 toward hinge 629 and increase the downward pressure of wheel 621 on the support surface, or to move wheel mount 623 away from frame member 627 and into a lower orientation than that depicted in FIGS. 16 and 17 if the upward pressure of the support surface on wheel 621 is sufficiently low.

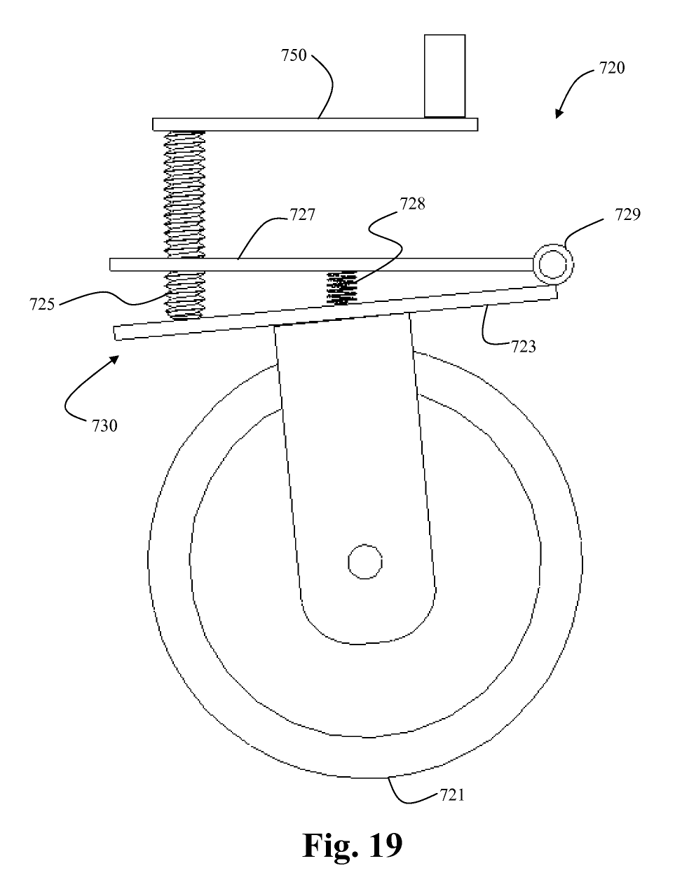

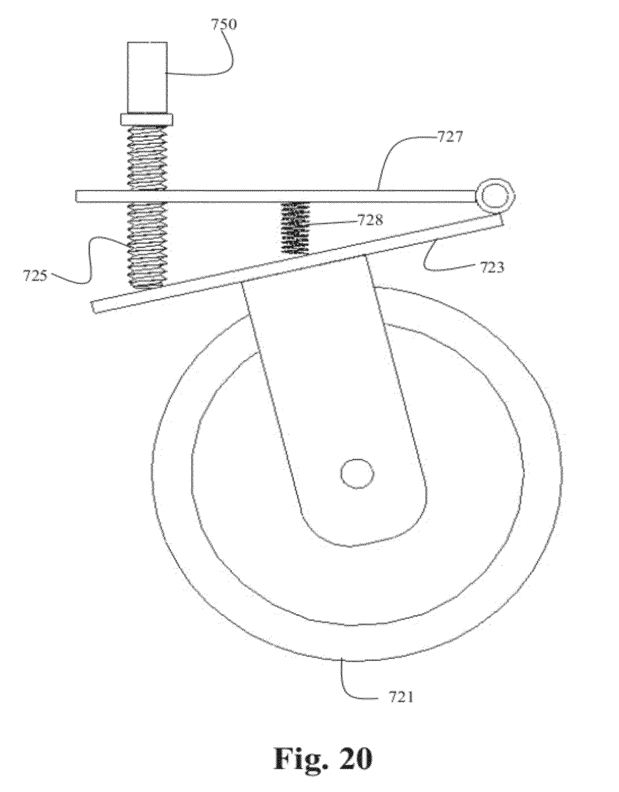

Depicted in FIGS. 19 and 20 is wheel assembly 720 according to another embodiment of the present disclosure. Wheel assembly 720 includes a wheel 721 connected to a wheel mount 723, which is attached to a frame member 727 by, for example, hinge 729. A wheel pressure actuator 730 is included for adjusting the force of wheel 731 on the support surface. A threaded aperture in frame member 727 receives a threaded member 725, which has a vertically oriented axis of rotation and is attached to a crank handle 750. A wheel lift member (for example spring 728) is included to apply a lifting force to wheel 721 once wheel 721 is no longer in contact with the support surface. In alternate embodiments the wheel lift member includes a coupling between threaded member 725 and wheel mount 723.

Rotation of handle 750 in one direction results in the downward extension of threaded member 725 and an increase in down pressure of wheel 723 on a support surface, or the downward movement of wheel mount 723 and wheel 721 if the force of wheel 723 on the support surface is sufficiently low.

FIG. 20 depicts wheel 721 in a downward extended position. Rotating handle 750 in the opposite direction results in a retraction of threaded member 725 and the raising of wheel 721.

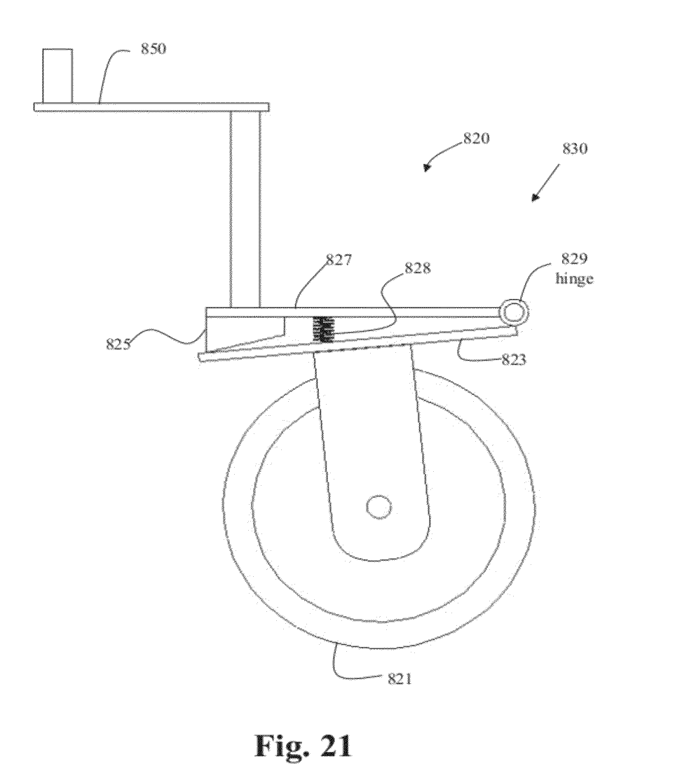

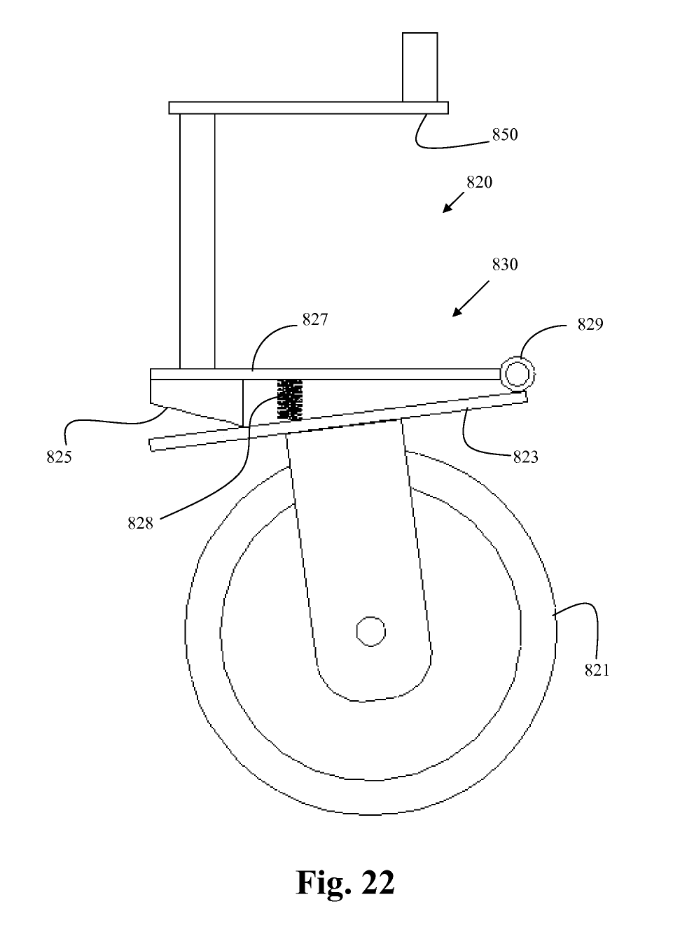

Depicted in FIGS. 21 and 22 is a wheel assembly 820 according to yet another embodiment of the present disclosure. Wheel assembly 820 includes a wheel 821 connected to a wheel mount 823, which is connected to a frame member 827. A wheel pressure actuator 830 is included for adjusting the force of wheel 821 on the support surface. A separation member (for example, wedge 825) is disposed between frame member 827 and wheel mount 823, and rotation of wedge 825 increases or decreases the downward pressure on wheel mount 823 and wheel 821. A wheel lift member (for example spring 828) can be used to facilitate upward movement of wheel 821 when wedge 825 is rotated to decrease the downward pressure on wheel mount 823.

In use, rotation of handle 850 rotates wedge 825 from a decreased downward pressure (or raised) wheel orientation as depicted in FIG. 21 to an increased downward pressure (or downward extended) wheel orientation as depicted in FIG. 22. Note that as handle 850 is further rotated from the orientation depicted in FIG. 22, the downward pressure exerted on wheel mount 823 by wedge 825 is decreased, thereby allowing wheel 821 to move upward due to, for example, the upward pressure of the support surface on wheel 821 and/or the upper pressure on wheel mount 823 by spring 828.

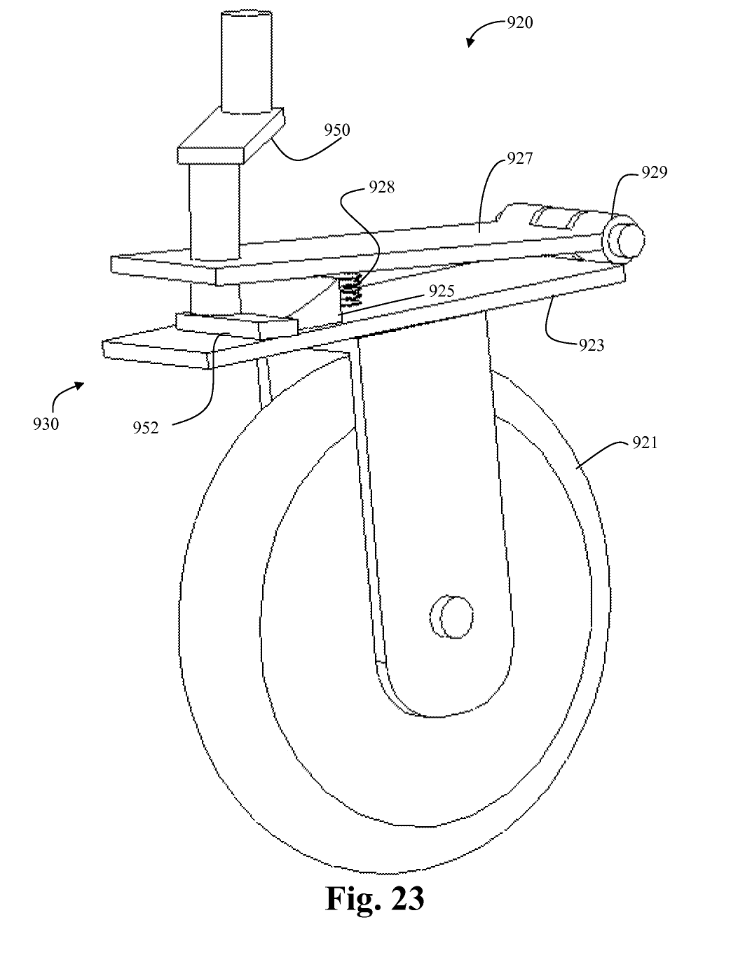

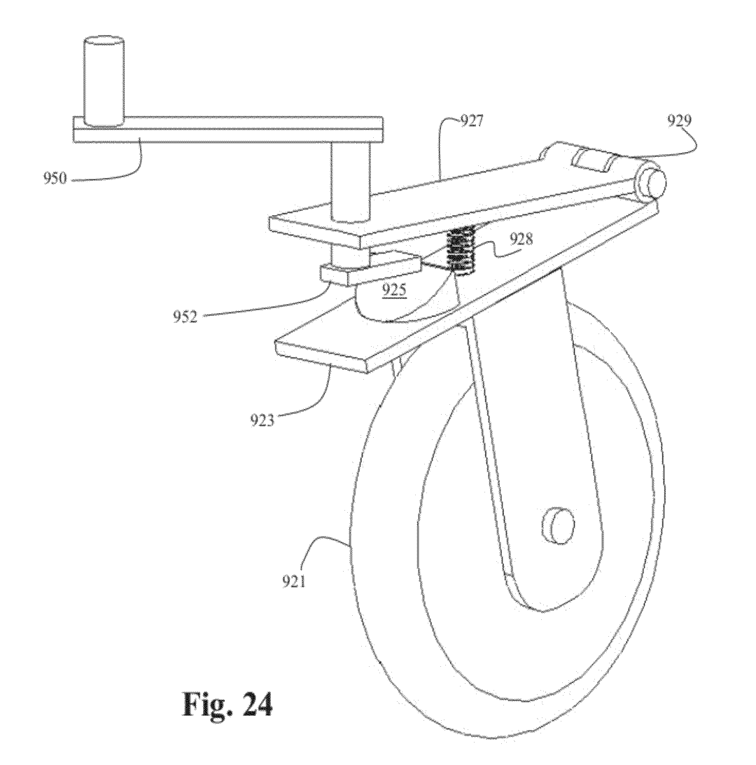

Depicted in FIGS. 23 and 24 is a wheel assembly 920 according to yet a further embodiment. Wheel assembly 920 includes a wheel 921 connected to a wheel mount 923, which is connected to a frame member 927. A wheel pressure actuator 930 is included for adjusting the force of wheel 921 on the support surface. A separation member (for example tab 952 and ramp 925) are disposed between frame member 927 and wheel mount 923. Rotation of handle 950 rotates tab 952, which increases or decreases the downward pressure on wheel mount 923 and wheel 921. A wheel lift member (for example spring 928) can be used to facilitate upward movement of wheel 921 when tab 952 is rotated to decrease the downward pressure on wheel mount 923.

In use, rotation of handle 950 rotates wedge 925 from a decreased downward pressure (or raised) wheel orientation as depicted in FIG. 23 to an increased downward pressure (or downward extended) wheel orientation as depicted in FIG. 24. Note that as handle 950 is further rotated from the orientation depicted in FIG. 24, the downward pressure exerted on wheel mount 923 by tab 952 interacting with ramp 925 is decreased, thereby allowing wheel 921 to move upward due to, for example, the upward pressure of the support surface on wheel 921 and/or the upper pressure on wheel mount 923 by spring 928.

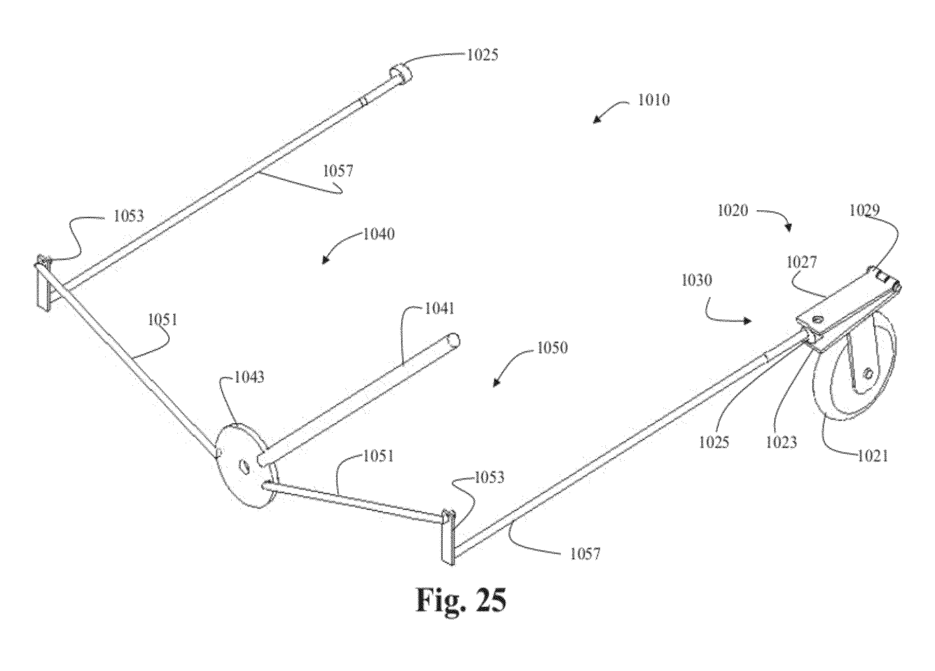

Another example wheel assembly and actuation assembly, shown as kit 1010, is depicted in FIGS. 25-28, which may be installed on a patient lift. Kit 1010 includes at least one wheel assembly 1020, a user input assembly 1040, and linkages 1050 connecting user input assembly 1040 to the one or more wheel assemblies 1020.

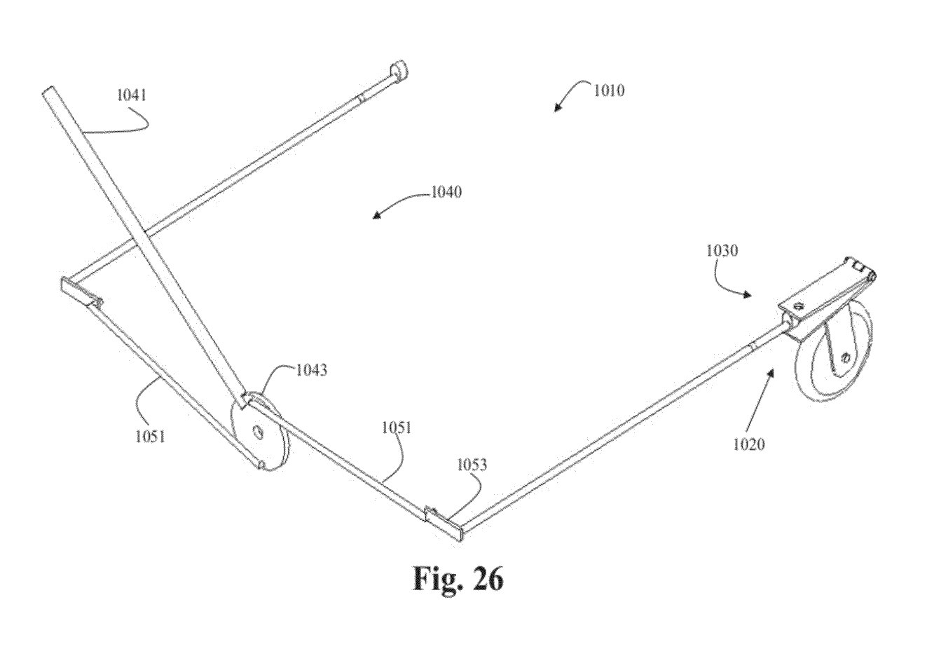

Each wheel assembly 1020 includes at least one wheel 1021, a wheel mount 1023 connected to the wheel, and a wheel pressure actuator 1030 for adjusting the force of wheel 1021 on the surface supporting the patient lift to which kit 1010 is attached. The wheel pressure actuator 1030 in FIGS. 25 and 26 includes a separation member (e.g., cam 1025), which can apply or remove a downward-directed force of wheel 1021 on the support surface. Wheel mount 1023 and frame member 1027 are connected by a member that allows application of downward force to wheel 1021, for example, a force directed to separate wheel mount 1023 and frame member 1027. In the illustrated embodiment, wheel mount 1023 and frame member 1027 are connected at one end by a hinge 1029.

Rotation of cam 1025 increases (or decreases) the force directed to separate frame member 1027 and wheel mount 1023. An increased separation force between wheel mount 1023 and frame member 1027 will increase the load carried by the wheel assembly 1020. If wheel 1021 is not in contact with the support surface (e.g., floor) or if the upward force of the support surface on wheel 1021 is sufficiently small, wheel 1021 will move downward. If wheel 1021 is already in contact with the support surface, wheel 1021 may not move downward as the separation force between wheel mount 1023 and frame member 1027 increases, increasing the load carried by wheel assembly 1020.

Cams 1025 are connected to torsion rods 1057. The axis of rotation of each torsion rod 1057 is horizontally oriented. Depending on the initial orientation of each cam 1025 and the direction of rotation of torsion rod 1057, the downward pressure of wheel 1021 is either increased or decreased as torsion rods 1057 are rotated.

Mounts, for example mounts similar to mounts 555 and 558 in FIGS. 11-15, may optionally be included and restrict the motion of torsion rod 1057 in directions perpendicular to the direction of rotation.

Each torsion rod 1057 is connected to a handle 1041. In the illustrated embodiment, each torsion rod 1057 is connected to a crank 1053, which in turn is connected to a push/pull rod 1051. Each push/pull rod 1051 is connected to a central crank 1043, which is connected to handle 1041.

In use, a user grasps and moves handle 1041, which in turn rotates cams 1025. As illustrated in FIGS. 25 and 26, a counterclockwise rotation of handle 1041 results in a counterclockwise rotation of crank 1043, which results in push/pull rods 1051 rotating torsion rods 1057 in opposite directions. Despite the opposite rotations of torsion rods 1057, the orientation of the cams 1025 results in a downward force being applied to each of the wheels 1021.

FIG. 25 depicts kit 1010 with handle 1041 rotated to deliver a minimal downward pressure of wheels 1021 on the support surface. Rotation of handle 1041 from the position depicted in FIG. 25 to the position depicted in FIG. 26 rotates cams 1025 to increase the pressure of wheels 1021 against the support surface. In situations where wheels 1021 move vertically, the movement of wheel 1021 may be imperceptible, the total travel in some embodiments being approximately ⅜ of one inch.

When wheel assemblies 1020 are actuated to decrease the downward pressure of wheels 1021 on the support surface (e.g., ground), the weight of patient lift to which kit 1010 is connected can force wheels 1021 upward until the weight of patient lift to which kit 1010 is connected (and any additional weight, such as the weight of a patient, being held by the patient lift) is distributed on the remaining wheels. To continue the upward motion of wheels 1021 and raise wheels 1021 off of the support surface, an optional lift member may be included. In one form, each lift member may include a spring 1028 to raise the corresponding wheel 1021 off of the support surface. In other embodiments, a slotted tongue-in-groove connection between wedge 1025 and wheel mount 1023 or other configuration connecting cam 1025, wheel mount 1023 and frame member 1027 are used to raise wheel 1021 off of the support surface.

Installation of kit 1010 on a patient lift, such as patient lift 1000, includes connecting user input assembly 1040, linkages 1050, and wheel assembly 1020 to the frame of patient lift 1000. For example, attachment members 1045, 1055 and 1058 (and optionally, frame member 1027 when included) may be connected to the frame of a patient lift. The remaining portions of kit 1010 (e.g., wheel assembly 1020, user input assembly 1040, and linkages 1050) may also be connected to patient lift 1000.

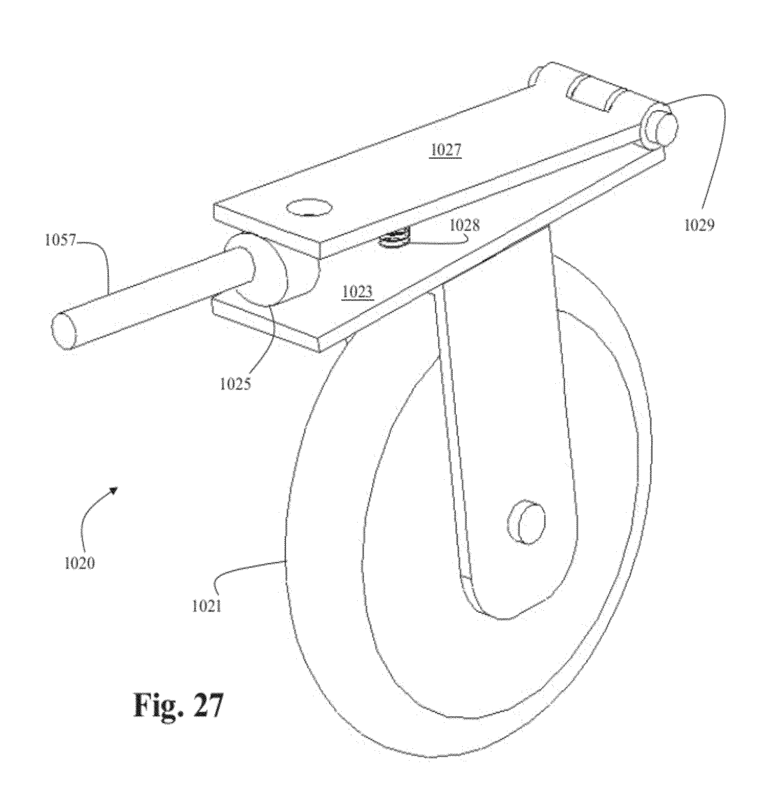

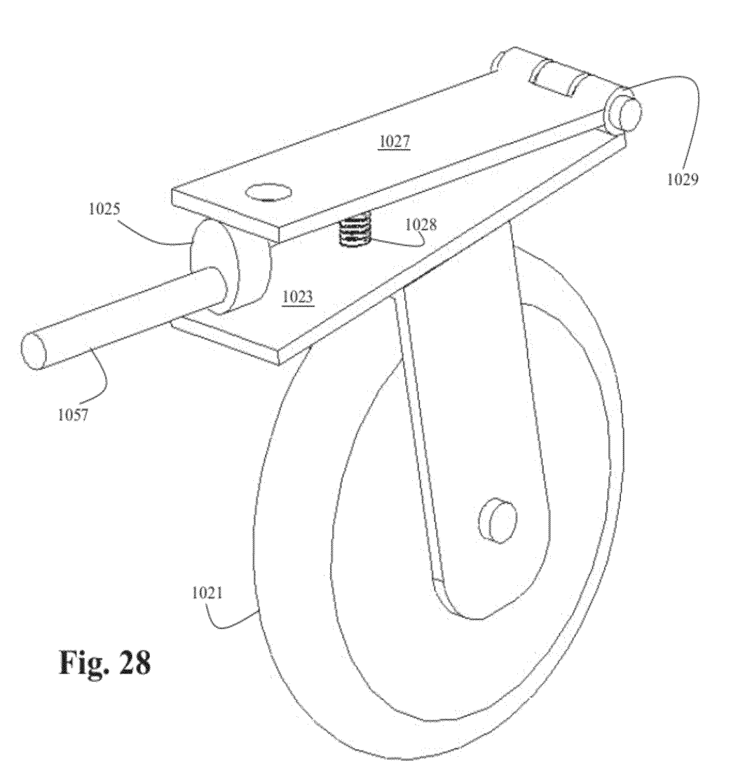

Depicted in FIGS. 27 and 28 is an expanded view of a wheel assembly 1020. FIG. 28 depicts the wheel assembly 1020 with wheel 1021 extended downward to a lower position than that depicted in FIG. 17. Wheel assembly 1020 may also be used with an alternate user input assembly similar to user input assembly 549 depicted in FIGS. 14 and 15.

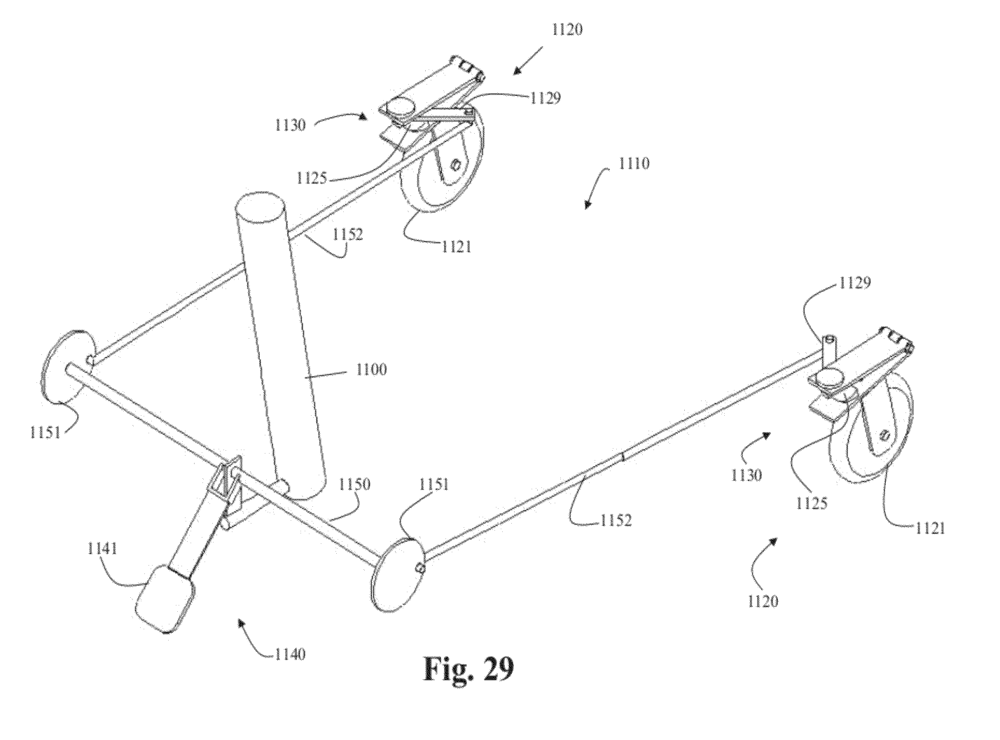

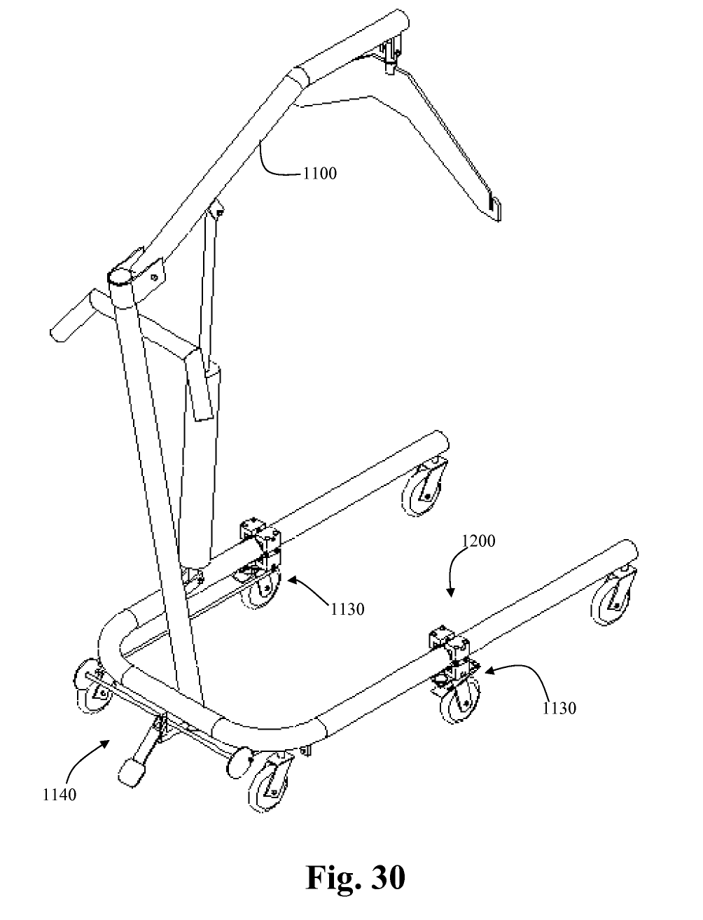

Still a further example wheel assembly and actuation assembly, which in the example is formed as kit 1110, is depicted in FIGS. 29 and 30, and which may be installed on a patient lift, such as patient lift 1100. Kit 1110 includes at least one wheel assembly 1120 and at least one user input assembly 1140. User input assembly 1140 is connected to wheel assembly by various linkages, which may include torsion members, push/pull members, and crank members. In the illustrated embodiment, user input assembly 1140 is connected to wheel assembly by a torsion rod 1150, which is connected to a cranking member 1151, which is connected to a push/pull rod 1152, which is connected to a lever 1129, which directly interacts with ramp 1125 to control the downward pressure applied to wheel 1121 and to the support surface. In another embodiment, lever 1129 rotates a tab to control the downward pressure applied to wheel 1121 similar to the embodiment depicted in FIGS. 23 and 24.

Mounts, for example mounts similar to mounts 555 and 558 in FIGS. 11-15, may optionally be included to restrict the motion of torsion rod 1157 in directions perpendicular to the direction of rotation.

In use, a user moves pedal 1141, which in turn rotates torsion rod 1150 and cranking members 1151, which push or pull push/pull rods 1152 and rotate levers 1129. As illustrated in FIGS. 29 and 30, an upward movement of pedal 1141 results in a clockwise (viewed from the right) rotation of torsion rod 1150 and cranking members 1151, which results in push/pull rods 1152 moving to the left (as depicted), rotating levers 1129 off of the ramps 1125, and decreasing the downward pressure of wheels 1121 on the support surface. Downward movement of pedal 1141 results in opposite movements and rotating levers 1129 onto ramps 1125, thereby increasing the downward pressure of wheels 1121 on the support surface.

An optional lift member (not shown) may be included to continue the upward motion of wheels 1121 and raise wheels 1121 off of the support surface once wheels 1121 are no longer pressing downward on the support surface. Example lift members include springs or other devices to raise wheels 1121 off of the support surface.

Installation of kit 1110 on a patient lift includes connecting user input assembly 1140, wheel assembly 1120, and the various linkages connecting user input assembly 1140 and wheel assembly 1120 to the frame of patient lift.

FIG. 30 depicts kit 1110 being connected to a patient lift 1100 using attachment members, such as one or more brackets 1200. Bracket 1200 may also be used to mount other wheel assemblies or other portions of a kit to a patient lift. For example, bracket 1200 may be used to mount the user input assembly to the patient lift. Bracket 1200 is capable of mounting wheel assemblies and portions of the wheel assembly kits to a variety of differently shaped patient lift structures, and may serve as a universal mounting member or a universal attaching member.

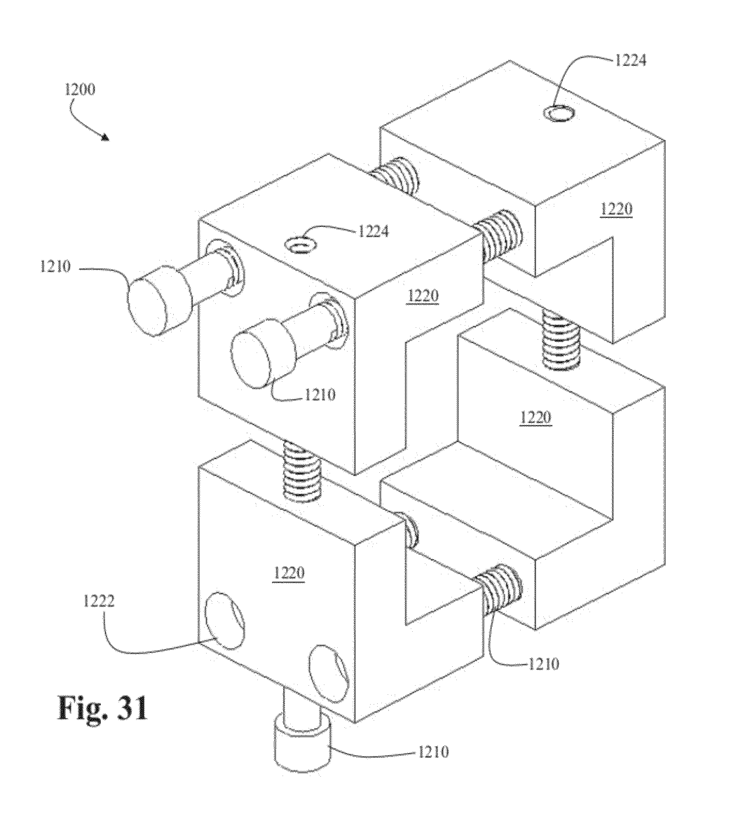

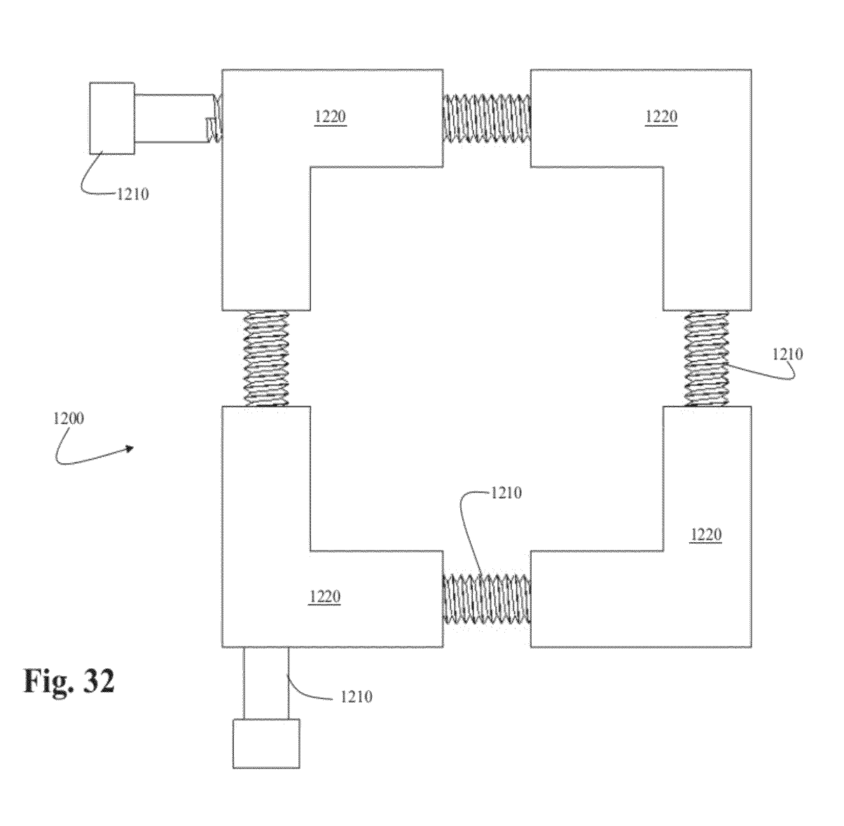

Bracket 1200 is depicted in greater detail in FIGS. 31 and 32. Bracket 1200 includes adjustment members that are capable of connecting bracket 1200 to a variety of different components of a patient lift. In the illustrated embodiment, the adjustment member includes one or more bolts 1210 and one or more receptacles, such as blocks 1220. At least one block 1220 includes at least one receptacle 1222 for receiving bolt 1210. At least one block 1220 includes a wheel assembly connector, such as receptacle 1224, for connecting bracket 1200 to a wheel assembly.

To install bracket 1200 on a patient lift, bracket 1200 is placed around a portion of the patient lift, such as by either inserting the portion of the patient left through interior space defined by bracket 1200, or by separating one or more bolts 1210 from a block 1220, placing the bracket 1200 around the patient lift portion and reattaching the one or more bolts 1210 to the block 1200 from which the one or more bolts had been separated.

Bracket 1200 may be connected to a wheel assembly using a wheel assembly connector, such as a bolt or similar device. In one example, the bolt is extended through an aperture in the wheel assembly and connected to receptacle 1224.

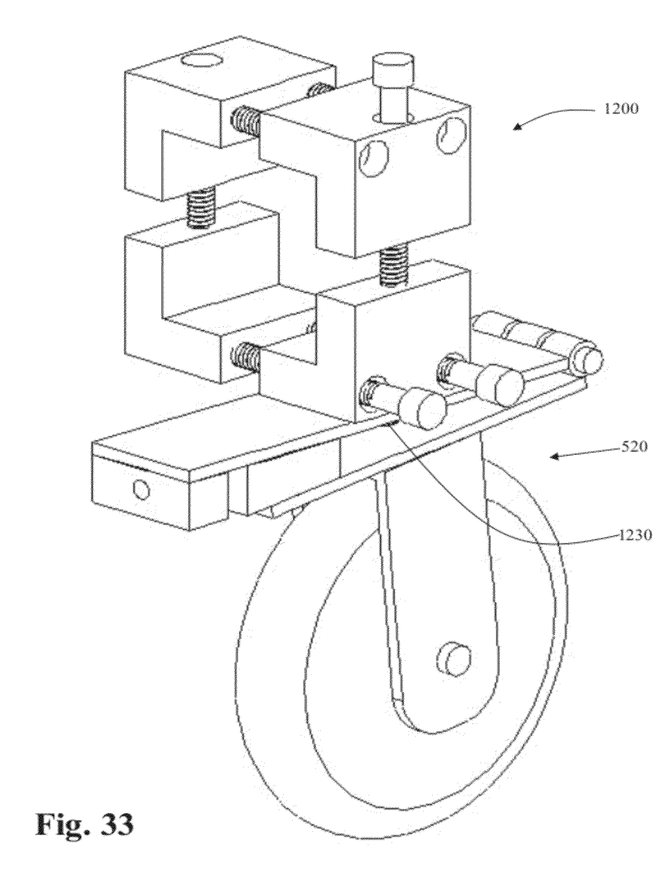

FIG. 33 depicts a bracket 1200 connected to a wheel assembly 520 using an attachment member, for example, connecting bolt 1230 inserted through an aperture in wheel assembly 520 (not depicted) and threadably engaged with a receptacle 1224. Bracket 1200 may be used to connect other wheels and wheel assemblies (such as load-bearing drive wheels 310; casters 116, 304, 411; and wheel assemblies 407, 520, 620, 720, 820, 920, 1020 and 1120) to patient lifts.

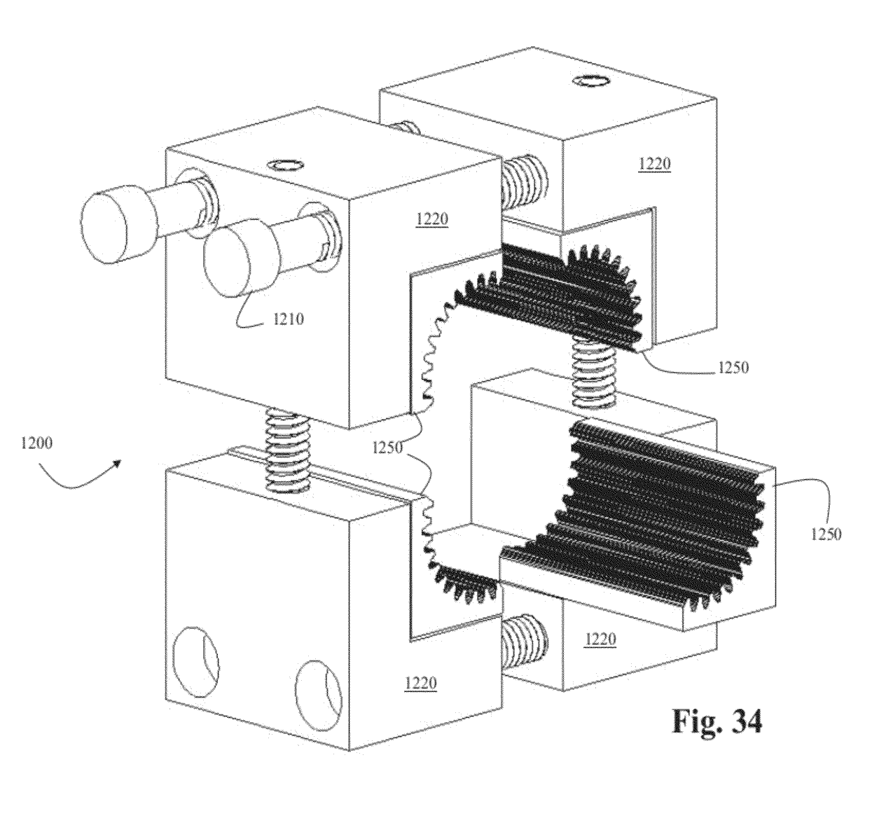

An adapter may optionally be used with a bracket 1200 to provide a better fit or better securement between bracket 1200 and the patient lift to which bracket 1200 is connected. For example, FIG. 34 depicts adapters 1250 being used in conjunction with bracket 1200. The inner edge of adapters 1250 are depicted as being circularly shaped, although other embodiments utilize different shapes for providing a secure fit to various forms of patient lifts. The inside edge of adapters 1250 is also scalloped, although other embodiments utilize a different form of textured surface and/or non-textured surfaces. Adapters 1250 may be attached to blocks 1220 using adhesives, tongue-in-groove connectors, or other types of fasteners that maintain the connection between adapters 1250 and blocks 1230 during installation. Once bracket 1200 is securely installed on a patient lift, each adapter 1250 is also held in position by the pressure of bracket 1200 on the patient lift.

The actuation assemblies depicted in FIGS. 11, 25 and 29 are not limited to use with the particular wheel assemblies depicted in FIGS. 11 and 25. For example, the actuation assembly depicted in FIG. 11 may be used with other wheel assemblies actuated by rotation of an actuation member about a horizontally disposed axis, such as one approximately parallel to the support surface, examples being the wheel assemblies depicted in FIG. 8. As another example, the actuation assembly depicted in FIG. 29 may be used with other wheel assemblies actuated by rotation of an actuation member around a vertically disposed axis, such as one approximately perpendicular to the support surface, examples being the wheel assemblies depicted in FIGS. 16, 19, 21, and 23

In an additional embodiment, one or more load-bearing wheel assemblies may be included in various locations on the patient lifter, such as the load-bearing wheels serving as one or more of the “front” wheels (the wheels located away from the post) or one or more of the “rear” wheels (the wheels located near the post).

While examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Exemplary embodiments have been shown and described, and all changes and modifications that come within the spirit of the invention are desired to be protected.

What is claimed is:

1. An adjustable load-bearing wheel assembly for a patient lift, comprising:
a wheel;
a force exertion member connectable to the wheel; and
an attachment member connectable to the force exertion member and to a patient lift;
wherein, when the wheel, the force exertion member and the attachment member are connected to the patient lift, actuation of the force exertion member in a first direction increases the force of the wheel on a support surface supporting the patient lift.

2. The assembly of claim 1, wherein the force exertion member includes a threaded member and actuation of the force exertion member in the first direction rotates the threaded member.

3. The assembly of claim 1, wherein the force exertion member includes a wedging member.

4. The assembly of claim 3, wherein the force exertion member includes a threaded member interacting with the wedging member, and wherein actuation of the force exertion member in the first direction rotates the threaded member.

5. The assembly of claim 3, wherein the force exertion member includes a cam interacting with the wedging member, and wherein actuation of the force exertion member in the first direction rotates the cam.

6. The assembly of claim 5, wherein the cam rotates about a vertically oriented axis.

7. The assembly of claim 5, wherein the cam rotates about a horizontally oriented axis.

8. The assembly of claim 3, wherein the wedging member includes a wedge that moves with respect to other portions of the force exertion member during actuation.

9. The assembly of claim 3, wherein the wedging member does not include a wedge.

10. The assembly of claim 1, wherein the force exertion member includes a hinge, and wherein actuation of the force exertion member results in actuation of the hinge.

11. The assembly of claim 1, wherein actuation of the force exertion member in a second direction decreases the force of the wheel on the support surface supporting the patient lift.

12. The assembly of claim 11, wherein actuation of the force exertion member in the second direction separates the wheel from the support surface.

13. The assembly of claim 12, further comprising a spring applying a force to separate the wheel from the support surface.

14. The assembly of claim 1, wherein the wheel, force exertion member, and attachment member form a kit for installation on a patient lift.

15. An adjustable load-bearing wheel assembly kit for a patient lift, comprising:
a plurality of adjustable load-bearing wheel assemblies, each as described in claim 1;
a user input component;
two force exertion members; and
a plurality of connectors, wherein operation of the user input component actuates the two force exertion members to increase the force of the wheels on the support surface when the plurality of adjustable load-bearing wheel assemblies and the user input component are connected to a patient lift and the plurality of connectors are connected to the wheel assemblies and the user input component.

16. The kit of claim 15, wherein the plurality of connectors include mechanical linkages.

17. The kit of claim 15, wherein the plurality of connectors include pathways for carrying electric signals.

18. The kit of claim 15, wherein the wheel assemblies, force exertion members, and connectors form a kit for installation on a patient lift.

19. A method, comprising:
attaching one or more adjustable load-bearing wheel assemblies to a patient lift, the patient lift including wheels that carry a load; and
actuating the one or more adjustable load-bearing wheel assemblies to support a portion of the load carried by the patient lift wheels.

20. The method of claim 19, comprising:
attaching a user input component to the patient lift; and
connecting the one or more adjustable load-bearing wheel assemblies to the user input component with one or more connectors, wherein operation of the user input component actuates the one or more adjustable load-bearing wheel assemblies to carry a portion of the load carried by the patient lift wheels via the one or more connectors.

21. The method of claim 19, wherein said actuating includes rotating a cam.

22. The method of claim 19, wherein said actuating includes rotating a threaded member.

23. The method of claim 19, wherein said actuating includes using a wedging member.

24. The method of claim 23, wherein said actuating includes moving a wedge.

25. The method of claim 23, wherein said actuating includes rotating a wedge.
